(19) United States
(12) Patent Application Publication
(10) Pub. No.: US 2021/0262849 A1
(43) Pub. Date: Aug. 26, 2021

(54) APPARATUSES, SYSTEMS, AND METHODS FOR PROVIDING A SMART LIQUID INFORMATION INDICATOR

(71) Applicant: DES-CASE CORPORATION, Goodlettsville, TN (US)

(72) Inventors: Eric Cooper Pride, Nashville, TN (US); Nikhil Rajkumar Gaikwad, Gallatin, TN (US); Shawn Curtis Garrison, Hendersonville, TN (US); Jay Michael Cooper, Nashville, TN (US); Kyle Anthony Dinger, Nashville, TN (US); Jonathan Lee Haworth, Hendersonville, TN (US)

(21) Appl. No.: 17/184,215

(22) Filed: Feb. 24, 2021

Related U.S. Application Data
(60) Provisional application No. 62/980,878, filed on Feb. 24, 2020.

(51) Int. Cl. G01F 23/292; G01N 21/27

(52) U.S. Cl. CPC G01F 23/292; G01N 21/27

(57) ABSTRACT

Apparatuses, systems, and methods are provided for a system for a smart liquid information indicator. A liquid reservoir may include a level indicator extending outwardly from the liquid reservoir. An inspection device for inspecting a liquid in a level indicator may be coupled to the level indicator. The inspection device may include a housing and a coupler coupling the housing to the level indicator of the liquid reservoir. At least a portion of the level indicator is received within an interior space of the housing when the housing is coupled to the level indicator. An imaging section may obtain at least one set of inspection data relating to the at least a portion of the level indicator. A communication section may transmit a representation of the at least one set of inspection data from the inspection device.

### CROSS-REFERENCES TO RELATED APPLICATIONS

This application claims priority to and benefit of U.S. Provisional Patent Application No. 62/980,878, filed Feb. 24, 2020, entitled “Apparatuses, Systems, and Methods for Providing a Smart Liquid Information Indicator,” and which is hereby incorporated by reference in its entirety.

A portion of the disclosure of this patent document contains material that is subject to copyright. The copyright owner has no objection to the authorized facsimile reproduction by anyone of the patent document or the patent disclosure, as it appears in the Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present disclosure relates generally to smart liquid level indicators and systems and methods for use therewith.

Oil level indicators (OLIs) are used to determine a fill level of a vessel. Typical vessels may be storage tanks, gearboxes, hydraulic systems, pumps, or similar that may be either completely non-transparent or may be only partially transparent. OLIs may be used to visibly mirror the oil level inside an oil reservoir. In some products an OLI might be completely shielded from view, for example behind metal. When OLIs are used there can be problems associated with ensuring that a headspace of the OLI above the oil is at a same pressure as that of the headsp ace of the oil reservoir for proper measurement. Furthermore, overfilling and underfilling of an oil reservoir can cause many issues that damage equipment. Challenges also extend to filling or draining a system that can vary under hot or cold temperature situations.

### BRIEF SUMMARY OF THE INVENTION

Implementations consistent with the present disclosure may solve problems associated with traditional devices by providing apparatuses, systems, and methods for providing a smart liquid level indicator.

As described above, problems exist in relation to monitoring a fluid level in liquid reservoirs. Thus, a need exists to improve monitoring of fluid levels in fluid reservoirs, including those with level indicators. Implementations consistent with the present disclosure may address various problems in this and other spaces by providing a remote monitor for use with a level indicator of a liquid vessel. By using implementations consistent with the present disclosure, numerous advantages may be provided in relation to remote visual monitoring of a level indicator, color change detection of a liquid remotely, etc.

Aspects of the embodiments described in the present disclosure may solve one or more of the aforementioned and other problems by providing an inspection device for inspecting a liquid in a level indicator of a liquid reservoir. The inspection device includes a housing having an interior space, a coupler configured to couple the housing to the level indicator of the liquid reservoir, wherein at least a portion of the level indicator is received within the interior space of the housing when the housing is coupled to the level indicator, a component section including an imaging section configured to obtain at least one set of inspection data relating to the at least a portion of the level indicator, and a communication section configured to transmit a representation of the at least one set of inspection data from the inspection device.

The inspection device may include a processing section having a storage, the processing section configured to perform at least one operation on a representation of the at least one set of inspection data and to store a post-processing representation of the at least one set of inspection data at the storage. The imaging section may include a camera module, wherein the at least one set of inspection data is an image of the at least a portion of the level indicator obtained by the camera module. The inspection device may include a lighting element within the housing, the lighting element having at least one illumination device configured to illuminate the interior space of the housing while the camera module is operable.

The inspection device may include a processing section having a storage which stores a plurality of images of the at least a portion of the level indicator obtained by the camera module and to selectively perform at least one operation upon at least one of the plurality of images. The housing may include an aperture. The camera module may provide an image of the interior space of the housing through the aperture, the camera module being configured at a constant distance from the at least a portion of the level indicator. The coupler may couple to at least one O-ring at an outer surface of the level indicator. The inspection device may receive at least one input parameter via the communication section, the at least one parameter relating to an operating parameter of the inspection device.

A further aspect of the present disclosure relates to a system for providing a smart liquid information indicator. The system includes a liquid reservoir, a level indicator extending outwardly from the liquid reservoir and configured such that a liquid level in the level indicator matches a liquid level in the liquid reservoir, and an inspection device for inspecting a liquid in a level indicator of a liquid reservoir. The inspection device includes a housing having an interior space, a coupler configured to couple the housing to the level indicator of the liquid reservoir, wherein at least a portion of the level indicator is received within the interior space of the housing when the housing is coupled to the level indicator, a component section including an imaging section configured to obtain at least one set of inspection data relating to the at least a portion of the level indicator, and a communication section configured to transmit a representation of the at least one set of inspection data from the inspection device.

The liquid reservoir may include a headspace, and the system may include a breather device coupled to the headspace of the liquid reservoir at a location thereof. The system may include a vent tube coupleable between the level indicator and the breather device at the headsp ace of the liquid reservoir, the vent tube configured to ensure equal pressurization at the level indicator as at the headsp ace of the liquid reservoir. The level indicator may include a breather device. The imaging section may include a camera module, wherein the at least one set of inspection data is an image of the at least a portion of the level indicator obtained by the camera module. The inspection device may include a processing section having a storage, the processing section, the processing section configured to store a plurality of images of the at least a portion of the level indicator obtained by the camera module and to selectively perform at least one operation upon at least one of the plurality of images. The system may also include (i) a network coupleable to the communication section of the inspection device, and (ii) an end device coupleable to the network, the end device including a display unit, the end device configured to receive at least one of the plurality of images from the inspection device and to display the at least one of the plurality of images or a representation thereof via the display unit. The end device may receive a plurality of inspection data from the inspection device and display at least a portion of the plurality of inspection data via the display unit as a graph of the at least a portion of the plurality of inspection data over time.

A further aspect of the present disclosure relates to a method for providing information relating to a liquid reservoir. The method begins by coupling an inspection device to a level indicator of the liquid reservoir. At least one inspection device parameter is obtained. A set of inspection data is obtained from the inspection device, the set of inspection data relating to a liquid in a level indicator of the liquid reservoir. The set of inspection data is processed to perform at least one operation on a representation of the set of inspection data. Information relating to the processed set of inspection data is then selectively conveyed from the inspection device.

The obtaining the at least one inspection device parameter may include obtaining the at least one inspection device parameter from an end device external to the inspection device. The performing at least one operation on the representation of the set of inspection data may include performing at least one image processing operation and storing a representation of the processed representation of the set of inspection data. The selectively conveying information relating to the processed set of inspection data may include transmitting the processed representation of the set of inspection data to an end device external to the inspection device via a network, and displaying at least a portion of the processed representation of the set of inspection data at the end device. The method may include receiving a plurality of inspection data from the inspection device at an end device external to the inspection device via a network and displaying at least a portion of the plurality of inspection data at the end device as a graph of the at least a portion of the plurality of inspection data over time.

Numerous other objects, features, and advantages of the present invention will be readily apparent to those skilled in the art upon a reading of the following disclosure when taken in conjunction with the accompanying drawings.

### BRIEF DESCRIPTION OF THE SEVERAL VIEWS OF THE DRAWINGS

FIG. 1 illustrates a partial view of an exemplary embodiment of a liquid reservoir system having a liquid level indicator and breather according to aspects of the present disclosure.

FIG. 2 illustrates a partial view of an exemplary embodiment of a liquid reservoir system including a vent tube and an inspection device according to aspects of the present disclosure.

FIG. 3 illustrates a partial perspective view of an exemplary embodiment of an inspection device coupled to a level indicator according to aspects of the present disclosure.

FIG. 4 illustrates a partial exploded view of an exemplary embodiment of an inspection device coupleable to a level indicator in accordance with aspects of the present disclosure.

FIG. 5 illustrates a partial view of an exemplary embodiment of an inspection device having at least one lighting element according to aspects of the present disclosure.

FIG. 6 illustrates a perspective view of a partial exploded view of an inspection device having an imaging section according to aspects of the present disclosure.

FIG. 7 illustrates an exemplary embodiment of an inspection device having a processing section according to aspects of the present disclosure.

FIG. 8 illustrates a partial lower perspective view of an exemplary embodiment of an interior portion of an inspection device according to aspects of the present disclosure.

FIG. 9 illustrates a partial side cutaway view of an inspection device coupled to a level indicator of a liquid reservoir according to aspects of the present disclosure.

FIG. 10 illustrates a block diagram of an exemplary embodiment of an inspection device according to aspects of the present disclosure.

FIG. 11 illustrates an exemplary embodiment of a functional network diagram of a system according to aspects of the present disclosure.

FIG. 12 illustrates an exemplary embodiment of a process for providing smart liquid level indication for a liquid reservoir according to aspects of the present disclosure.

FIG. 13 illustrates a partial side perspective view of an exemplary embodiment of a liquid reservoir system according to aspects of the present disclosure.

FIG. 14 illustrates a partial side perspective view an exemplary embodiment of the liquid reservoir system of FIG. 13 according to aspects of the present disclosure.

FIG. 15 illustrates a partial side perspective view of the liquid reservoir system of FIG. 13 according to aspects of the present disclosure.

FIG. 16 illustrates a partial side perspective view of an exemplary embodiment of an inspection device coupled to a liquid reservoir of FIG. 13 according to aspects of the present disclosure.

FIG. 17 illustrates a partial cross section view of a liquid reservoir of FIG. 13 according to aspects of the present disclosure.

FIG. 18 illustrates a partial side perspective view of an exemplary embodiment of a remote viewing liquid reservoir system according to aspects of the present disclosure.

FIG. 19 illustrates a partial network diagram of an exemplary embodiment of a system according to aspects of the present disclosure

### DETAILED DESCRIPTION

While the making and using of various embodiments of the present disclosure are discussed in detail below, it should be appreciated that the present disclosure provides many applicable inventive concepts that can be embodied in a wide variety of specific contexts. The specific embodiments discussed herein are merely illustrative of specific ways to make and use aspects of the present disclosure and do not delimit the scope of the invention.

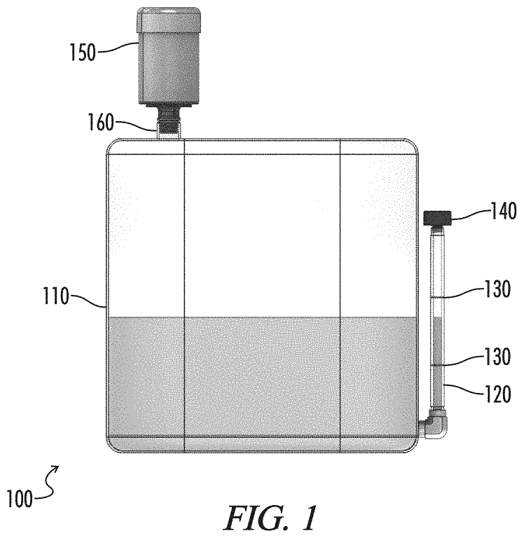

FIGS. 1-19 illustrate various exemplary apparatuses, systems, and associated methods according to the present disclosure that are described below. Where the various figures may describe embodiments sharing various common elements and features with other embodiments, similar elements and features are given the same reference numerals and redundant description thereof may be omitted below.

Various embodiments of an apparatus according to the present disclosure may provide apparatuses, systems, and methods for providing a smart liquid information indicator.

FIG. 1 illustrates a partial view of an exemplary embodiment of a liquid reservoir system having a liquid level indicator and breather according to aspects of the present disclosure. The liquid reservoir system 100 may include a liquid reservoir 110 configured to contain a liquid. In various embodiments the liquid may be oil, such as a traditional oil, synthetic oil, synthetic blend, or any other type of oil or lubricating liquid. Additionally or alternatively, the liquid may be or include water or any other liquid capable of storage within the liquid reservoir 110, either in whole or in part. The liquid reservoir 110 may include a level indicator 120 coupled to the liquid reservoir 110 or coupleable to the liquid reservoir. The level indicator 120 may include an inspection section 130 having a first end and a second end, whereby an inspection of at least a portion of a liquid of the liquid reservoir 110 contained in the level indicator 120 may be inspected. Inspection of the level indicator 120 may include, for example, a liquid level inspection, a liquid clarity inspection, a liquid consistency inspection, or any other liquid or air inspection measurement, either alone or in combination with one another. The level indicator 120 may include a cap 140 at an end thereof. The cap 140 may be a sealing cap in various embodiments, although the cap 140 may optionally include one or more elements configured to permit at least one of air and/or liquid to pass therethrough, for example as disclosed herein with reference to vent tube 220. Additionally or alternatively, the cap 140 may be or may include a breather device similar to breather 150. The breather device of cap 140 may be either a desiccant or non-desiccant breather device. The pressure above the liquid of the liquid reservoir 110 and above the liquid in the level indicator 120 may be equal to one another and may be equal to an ambient pressure outside the liquid reservoir 110.

A breather 150 may be coupleable to the liquid reservoir 110. The breather 150 may be a desiccant breather coupleable to a headspace of the liquid reservoir 110 and may be of a type, for example, as described and illustrated by U.S. Pat. No. 10,213,725 assigned to the Applicant of the instant application, although any breather device or element may be used without departing from the spirit and scope of the present disclosure. The breather 150 may be coupleable to the liquid reservoir 110 at a location 160 or the liquid reservoir 110. The breather 150 may be coupleable to the liquid reservoir 110 such that air from a headsp ace of the liquid reservoir may be configured to enter into and pass through the breather 150.

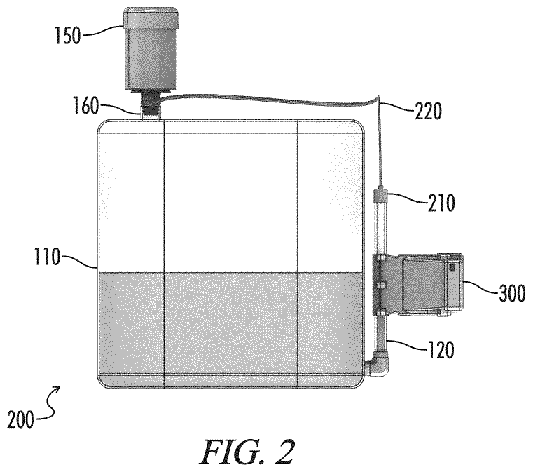

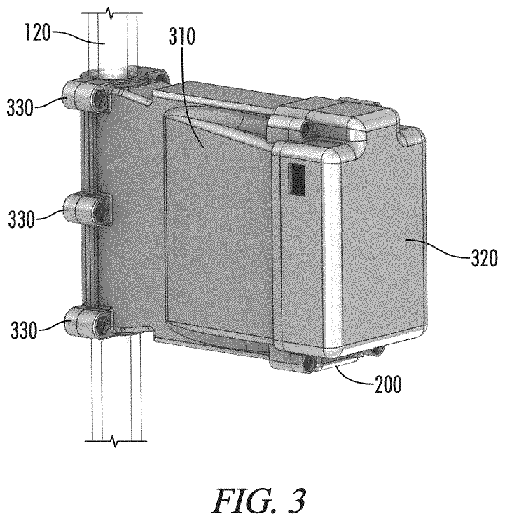

FIG. 2 illustrates a partial view of an exemplary embodiment of a liquid reservoir system including a vent tube and an inspection device according to aspects of the present disclosure. The liquid reservoir system 200 includes a liquid reservoir 110 having or otherwise coupleable to a level indicator 120. A breather 150 may be coupled to or coupleable to the liquid reservoir 110 at a location 160. The level indicator 120 may include a cap 210 coupled or coupleable thereto. The cap 210 may attach to a vent tube 220. The vent tube 220 may extend to the location 160 and/or breather 150 in various embodiments. The vent tube 220 may enable an airspace at and end of the level indicator 120 to be vented back to a headspace of the reservoir 110. This venting may assume, for example, that the pressures above the liquid of the level indicator 120 and above the liquid of the liquid reservoir 110 are the same and may be equal to an ambient pressure outside the liquid reservoir 110. In various embodiments where the breather 150 includes a check valve or pressure can change differently than an ambient pressure, the pressure at the headsp ace above a liquid of the liquid reservoir 110 may be the same as that of that above a liquid of the level indicator 120. An inspection device 300 is coupled to the level indicator 120 of FIG. 2. The inspection device 300 is further described herein with reference to FIG. 3 and throughout the instant specification. Although not illustrated in FIG. 1 it should be appreciated that an inspection device 300 may be coupleable to the level indicator 120 of the liquid reservoir 110 of FIG. 1 in the same manner illustrated and described herein with reference to FIG. 2 and throughout the instant specification. In various embodiments, a size and shape of the inspection device 300 may be configured to correspond to a low and high mark on a level indicator 120 such that visual inspection O-rings or markers on the level indicator 120 are not necessary.

FIG. 3 illustrates a partial perspective view of an exemplary embodiment of an inspection device coupled to a level indicator according to aspects of the present disclosure. An inspection device 300 may include a housing 310. The housing 310 may include a component section 320 configured to house at least one inspection component therein. The housing 310 may be coupleable to at least a portion of the level indicator 120 at a coupler 330 of the housing 310. At least a portion of the interior space of the housing 310 may be an opaque color or material designed to reduce light pollution for a camera module of the inspection device 300. A longitudinal length of the housing 310 may be a predetermined distance from the level indicator 120 in various embodiments. In providing a predetermined depth, one or more image settings may be calibrated to correspond to the predetermined depth (e.g., focus settings, etc.).

The coupler 330 may be or include a through hole or opening, a screw, a nut, a hook and loop fastener, or any other fastening element configured to fixedly or moveable couple the housing 310 to the level indicator 120. Although illustrated as having three couplers 330 in FIG. 3, it should be appreciated that any number of couplers 330 may be used without departing from the spirit and scope of the present disclosure. In various embodiments, the inspection device 300 is configured to perform at least one inspection operation corresponding to a liquid in the level indicator 120, for example between the first end and the second end of the inspection section 130. The inspection operation may include a liquid level or color determination for liquid contained in the level indicator 120 in various embodiments. Additionally or alternatively, the inspection operation may include a contamination determination of the liquid in the level indicator 120. Although described above as separate inspection operations, it should be appreciated that both of the liquid level determination and the contamination determination may be performed based at least in part upon the same image or image obtained at the inspection device 300. In various embodiments, contamination may be detected using image processing techniques such as, for example, pixel editing, image blending, image masking, geometric transformations, code optimization, smoothing images, morphological transformations, canny edge detection, Hough line transform, Histograms, or the like.

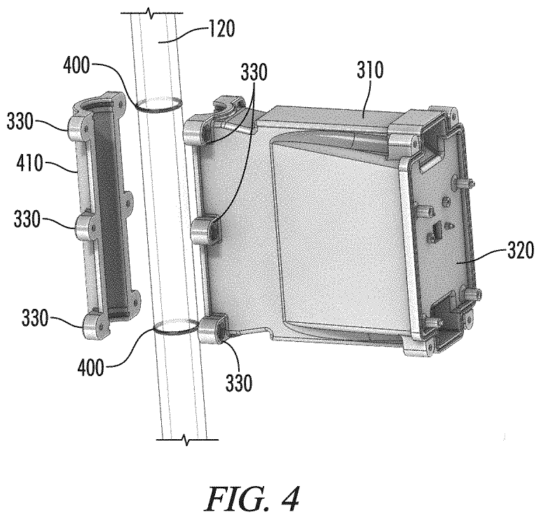

FIG. 4 is a partial exploded view of an exemplary embodiment of an inspection device coupleable to a level indicator in accordance with aspects of the present disclosure. The inspection device 300 of FIG. 4 includes a housing 310, component section 320, and at least one coupler 330. The component section 320 is shows an interior space of the component section 320 with a cover thereof removed relative to the view illustrated by FIG. 3. The interior space of the component section 320 may house, either in whole or in part, one or more components configured to permit the inspection device 300 to operate. The one or more components may include, an image recording device, a lighting element, a power source such as a battery or electrical connector, or any other component capable of providing structural and/or operational benefit to the inspection device 300 or element or component coupleable thereto. One or more sealing elements 400 may be placed on the level indicator 120, for example when coupling the inspection device 300 to the level indicator 120. In an exemplary embodiment, at least one of the one or more sealing elements 400 may be an existing high or low marking on a level indicator 120, such as an O-ring or other visual indicia. Additionally or alternatively, an O-ring, a gasket, a clamp, and/or a seal may be a sealing element 400 as described herein and may be used, in whole or in part, to block external elements from an interior space of the housing 310 such as light, dust, heat, cold, or other external element which might affect operation of the inspection device 300. In various exemplary embodiments, the housing 310 (including the component section 320) may be sealed to achieve an Ingress Protection (IP) rating sufficient to keep out dust that could influence image processing.

The housing 310 may include a removably attachable housing securing portion 410. The housing securing portion 410 may be configured to be secured to the housing 310 at one or more couplers 330. At least one coupler 330 of the housing securing portion 410 is configured to correspond to at least one coupler 330 of the housing 310. The coupler 330 may include a fastening element such as a through hole for receiving a screw, a nut, a hook and loop fastener, a clamp, or any other fastening element configured to fixedly or moveable couple the housing 310 and housing securing portion 410 to the level indicator 120. Although illustrated as having three couplers 330 in FIG. 3, it should be appreciated that any number of couplers 330 may be used without departing from the spirit and scope of the present disclosure. The housing 310 and/or housing securing portion 410 may be configured with at least one cutout portion corresponding to at least one sealing element, for example as illustrated at both top and bottom ends of the housing securing portion 410. A similarly implemented cutout portion may be provided at the housing 310 in the manner illustrated at the housing securing portion 410.

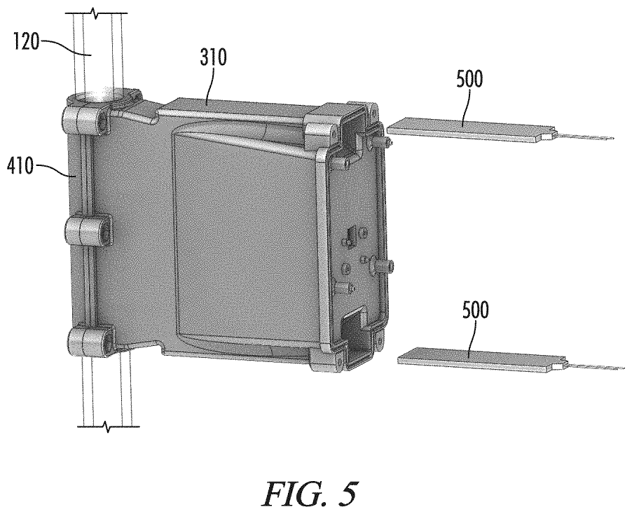

FIG. 5 illustrates a partial view of an exemplary embodiment of an inspection device having at least one lighting element according to aspects of the present disclosure. The housing 310 of FIG. 5 is coupled to a housing securing portion 410, the combination of which is coupled to the level indicator 120. The housing 310 of the inspection device 300 may include one or more openings capable of receiving at least a portion of a lighting element 500. The lighting element 500 may include a body having one or more illumination devices thereupon for providing light to an interior space of the inspection device 300. The one or more illumination devices may include one or more light emitting diode (LED) elements, one or more incandescent lighting elements, or any other element or device capable of providing illumination to an interior space of the inspection device 300. Illumination provided to the interior space of the housing 310 of the inspection device 300 may be provided to reduce or eliminate the effects of ambient light external to the inspection device which might be received within the interior space of the inspection device 300, for example via the level indicator 120 when the inspection device 300 is coupled to the level indicator 120. One or more electrically communicative elements or leads may extend outwardly from a surface of at least one lighting element 500 and may be configured to provide operating power to the at least one lighting element 500 from a power source included with the inspection device 300, a power source external to the inspection device 300, or combination thereof.

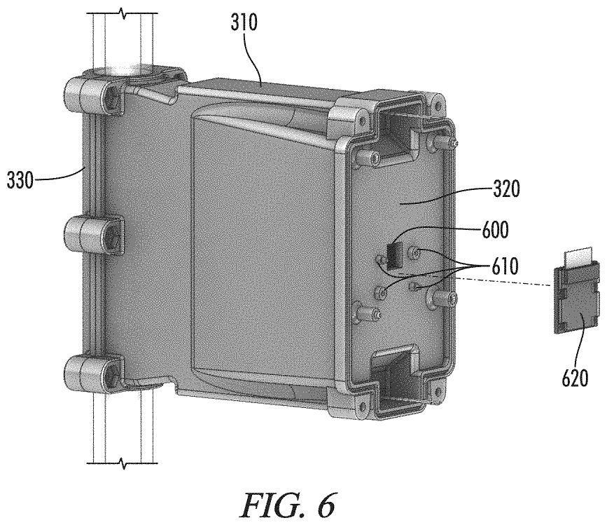

FIG. 6 illustrates a perspective view of a partial exploded view of an inspection device having an imaging section according to aspects of the present disclosure. The component section 320 is open an exposed in the illustration provided by FIG. 6. The component section 320 may include an aperture 600 into the housing 310 and one or more fastening locations 610 configured to couple with an imaging section 620. The imaging section 620 may include an imaging component such as a camera module configured to capture at least one of image and/or audio associated with the level indicator 120, for example through the aperture 600. Although described as an imaging section 620 it should be appreciated that the imaging section may include one or more sensors or elements capable of obtaining one or more non-visual data sets corresponding to the level indicator 120. For example, the imaging section 620 may include an audio element capable of obtaining audible data relating to the level indicator 120 during operation (for example to be used to correlate to one or more event or condition statuses such as malfunction, overfilling or underfilling condition, or normal operating condition criteria). In an exemplary embodiment, the imaging section 620 includes a camera module having sufficient resolution parameters corresponding to the fixed distance between the aperture 600 and the level indicator 120 so as to provide a sufficient resolution image for operations described herein.

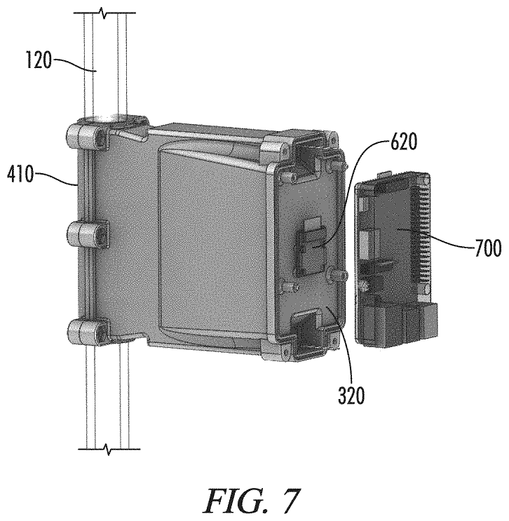

FIG. 7 illustrates an exemplary embodiment of an inspection device having a processing section according to aspects of the present disclosure. The inspection device 300 optionally includes a processing section 700 coupleable to the inspection device, for example at the component section 320. The processing section 700 may include a circuit board including a processor and memory, the processing section 700 configured to obtain at least one set of inspection data from the imaging section 620 and to perform at least one processing operation in association with the at least one set of inspection data. The at least one operation may include a data processing operation such as an image processing operation, an inspection data storage operation whereby at least a portion of inspection data is stored (either before or after processing by the processing section 700, or any other operation on inspection data or control operation associated with the inspection device 300 (received at the inspection device 300 or receivable at the inspection device 300). The processing section 700 may optionally include a power source such as a battery or connector configured to receive power from an external source, such as an alternating current (AC) and/or direct current (DC) power source. The power source of the processing section 700 may be configured to provide operating power to one or more components of the inspection device, such as the imaging section 620, lighting element 500, or any other element of the inspection device 300 or element coupleable therewith.

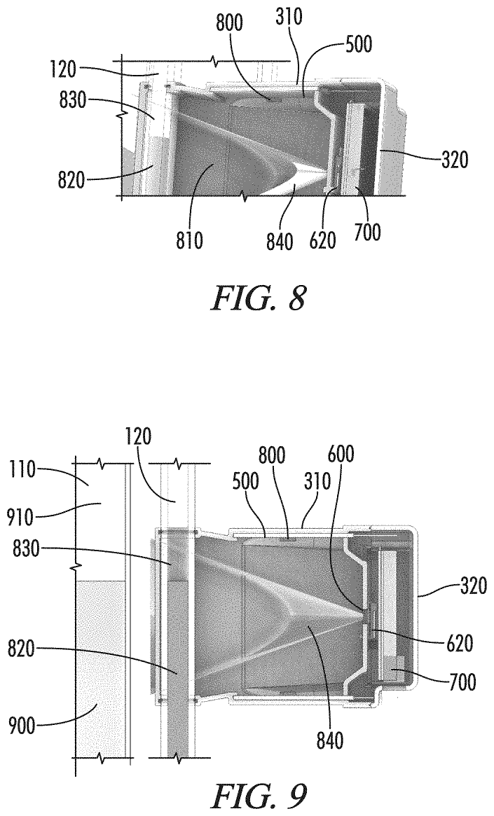

FIG. 8 illustrates a partial lower perspective view of an exemplary embodiment of an interior portion of an inspection device according to aspects of the present disclosure. The housing 310 includes an interior section 810 having an opaque interior configured to reduce the effect of light received within the interior section 810 from an external source (for example via one or more translucent sections of the level indicator 120). The housing 310 of the inspection device 300 includes a lighting element 500 having an LED lighting source 800 coupled thereto. The housing 310 further includes a component section 320 having a processing section 700 coupled to an imaging section 620 configured to obtain at least one data measurement relating to the level indicator 120 through the aperture 600. The embodiment illustrated by FIG. 8 includes a camera module having a field of view 840 appropriately configured to view an inspection section (e.g., inspection section 130) of the level indicator 120 based at least in part upon a known longitudinal distance of the imaging section 620 from the level indicator 120. The imaging section 620 is configured to obtain at least one set of inspection data relating to one or more of a liquid-filled section 820 and/or empty section 830 of the level indicator 120.

FIG. 9 is a partial side cutaway view of an inspection device coupled to a level indicator of a liquid reservoir according to aspects of the present disclosure. The housing 310 of the inspection device 300 includes one or more of the identically numbered elements of FIG. 8 above. FIG. 9 additionally illustrates how the liquid-filled section 900 and the empty section 910 of the liquid reservoir 110 correspond to the liquid-filled section 820 and empty section 830 of the level indicator 120.

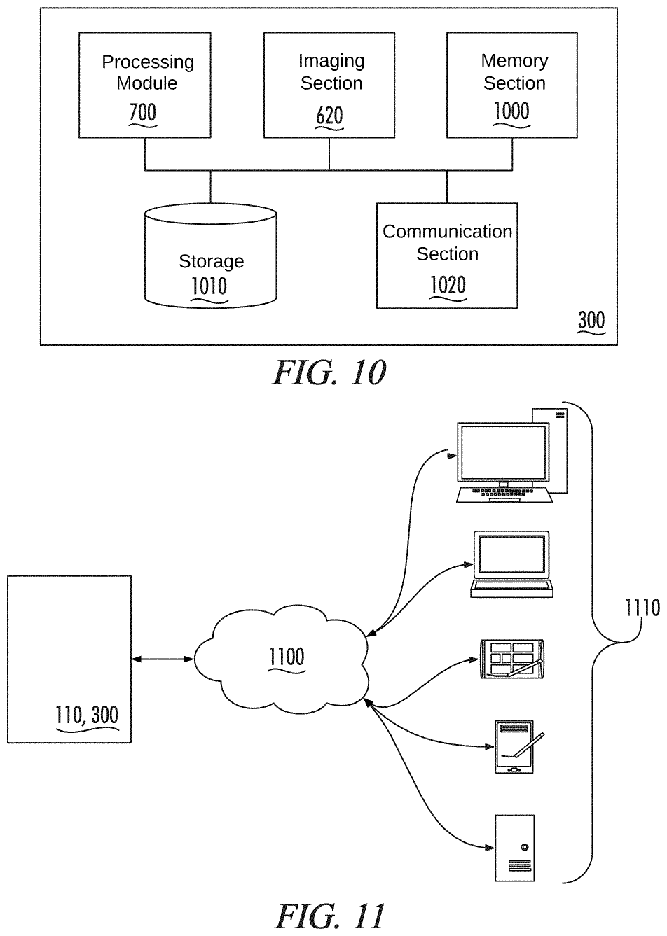

FIG. 10 is a block diagram of an exemplary embodiment of an inspection device 300 according to aspects of the present disclosure. The inspection device 300 includes one or more of: a processing section 700, an imaging section 620, a memory section 1000, a storage 1010, and/or a communication section 1020. Two or more of the processing section 700, the imaging section 620, the memory section 1000, the storage 1010, and/or the communication section 1020 may be communicatively coupleable to one another via at least one bus. The bus may be any wired or wireless communication medium capable of transmitting information from at least one element and to at least one element. The processing section 700 is configured to perform at least one processing operation in the manner described herein, for example corresponding to at least one set of inspection data obtained by the imaging section 620. The memory section 1000 is optionally configured to provide a volatile or non-volatile storage for use by the processing section 700 and/or at least one element remote from the inspection device 300.

The inspection device 300 may include a storage 1010 configured in one or more embodiments to provide storage for inspection data, for example at least one set of data obtained by the imaging section 620, and/or one or more sets of instructions for performing or controlling at least one operation associated with the inspection device 300, either in a permanent or temporary storage. Additionally or alternatively, at least a portion of the storage 1010 and/or memory section 1000 may be physically and/or logically separate from the inspection device. For example, at least a portion of data corresponding to the storage 1010 may be physically stored external to the storage 1010, for example in a cloud computing storage system, may be accessible by the processing section 700 via the storage 1010 and/or memory section 1000 addressing system(s), or may be accessible to the processing section 700 to an external data storage via the communication section 1020.

The communication section 1020 provides a wired and/or wireless communication interface for the inspection device 300 to communicate with at least one remote entity. The communication section 1020 may provide access by the inspection device 300 to one or more public or private networks. In an exemplary embodiment, the communication section 1020 includes a wireless transceiver capable of permitting the inspection device 300 to connect wirelessly to the Internet. Additionally or alternatively, the communication section 1020 is configured to provide wireless access to a private network, such as an on-premises control or general applicability wireless network and transmit and/or receive data to and from the private network. The communication section 1020 may be further configured to provide simultaneous or non-simultaneous access to both public and private networks during operation. The communication section 1020 may optionally include a cellular communication transceiver to permit wireless communications where no existing wireless network (e.g., a traditional Wi-Fi network) is accessible or operable.

FIG. 11 is an exemplary embodiment of a functional network diagram of a system according to aspects of the present disclosure. The system includes a liquid reservoir 110 coupled to an inspection device 300 in the manner previously described herein. The inspection device 300 is communicatively coupleable to a network 1100 via the communication section 1020. As previously described, the network 1100 may be a public and/or private network and may include the public Internet in various embodiments. One or more end device(s) 1110 may also be coupleable to the network 1100 in a similar manner to that of the inspection device 300 via the communication section 1020. One or more computing component such as an end device 1110 and/or functional operation described herein with reference to any computing element may be connected to or otherwise accessible via a network such as the network 1100. In one exemplary embodiment, the network 1100 includes the Internet, a public network, a private network, or any other communications medium capable of conveying electronic communications. Connection between elements or components is configured to be performed by wired interface, wireless interface, or a combination thereof, without departing from the spirit and the scope of the present disclosure. In one exemplary operation, at least one computing component and/or functional element is configured to store one or more sets of instructions in a storage element. The one or more sets of instructions may be configured to be executed by a microprocessor to perform operations corresponding to the one or more sets of instructions.

In various exemplary embodiments, at least one end device 1110 is implemented as at least one of a desktop computer, a server computer, a laptop computer, a smart phone, or any other electronic device capable of executing instructions. The microprocessor may be a generic hardware processor, a special-purpose hardware processor, or a combination thereof. In embodiments having a generic hardware processor (e.g., as a central processing unit (CPU) available from manufacturers such as Intel and AMD), the generic hardware processor is configured to be converted to a special-purpose processor by means of being programmed to execute and/or by executing a particular algorithm in the manner discussed herein for providing a specific operation or result.

One or more end device 1110 and/or functional element may be configured to operate remotely and may be further configured to obtain or otherwise operate upon one or more instructions stored physically remote from the computing component and/or functional element (e.g., via client-server communications and/or cloud-based computing).

At least one computing component may include a display unit. The display unit may be embodied within the end device 1110 in one embodiment and may be configured to be either wired to or wirelessly interfaced with at least one other computing component or functional element. The display unit may be configured to operate, at least in part, based upon one or more operations of the described herein, as executed by a microprocessor.

At least one end device 1110 may additionally or alternatively be implemented by a physical and/or virtual server. In such an embodiment, the server may be configured to obtain at least one set of information relating to an inspection device 300 (e.g., directly or indirectly from an inspection device 300 via the network 1100) and/or may obtain at least a set of data or metadata relating to the same from the inspection device 300 and/or a separate element. The server may be configured as an interface by which one or more end devices 1110 may be permitted to obtain information relating to an inspection device 300 and/or to provide information or control commands relating to an inspection device. This may be accomplished, for example, by a web server provided by the server or an alternative configuration whereby the server may convey information to at least one end device 1110, perform at least one operation relating to the inspection device 300, and/or convey at least one command to the inspection device 300.

At least one end device 1110 may have an application or other software element installed thereupon or accessible thereto which is configured to convey at least one set of information relating to an inspection device 300 to a user, for example via a display unit as previously described. Additionally or alternatively, an end device 1110 may access the at least one set of information from a remote computing device, for example via the network 1100, and may optionally provide at least one set of device parameters and/or control information or commands to the inspection device 300 (e.g., via the network 1100).

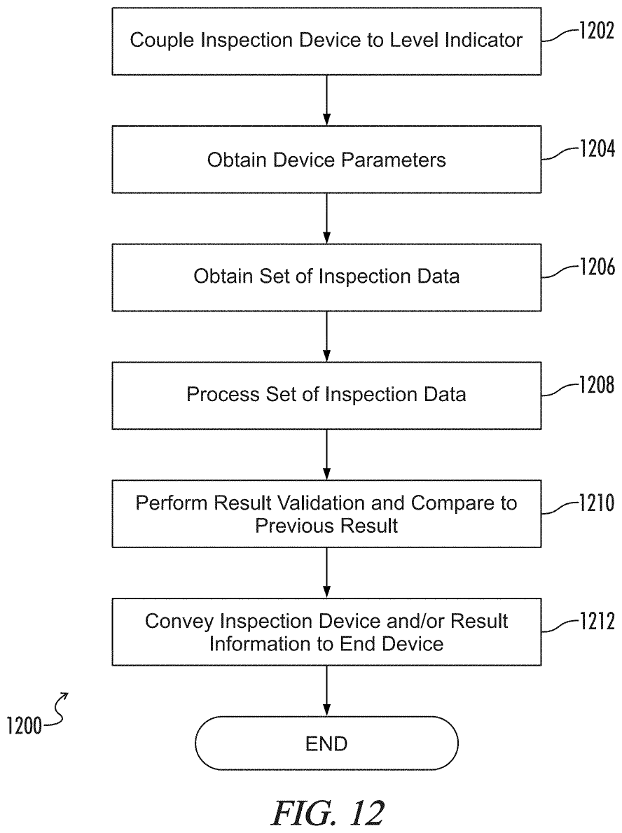

FIG. 12 illustrates an exemplary embodiment of a process for providing smart liquid level indication for a liquid reservoir according to aspects of the present disclosure. The process 1200 begins at an operation 1202 where an inspection device 300 is coupled to a level indicator 120. The inspection device 300 may be coupled to the level indicator 120 for example using the housing securing portion 410 secured to the housing 310 of the inspection device 300 via one or more couplers 330. Either before of after coupling the inspection device 300 to the level indicator 120, one or more device parameters may be obtained at an operation 1204. In an exemplary embodiment, at least one parameter may be obtained from a customer (e.g., end user) via at least one end device 1110. The customer may provide at least one set of information relating to one or more of: (i) a height, width, and/or length of liquid reservoir; (ii) an image acquisition frequency; (iii) high- and low-level alarm information (e.g., for both idle and run values in an exemplary embodiment); (iv) a request to obtain a current image and level information; and/or (v) a cost per gallon of liquid in use.

A set of inspection data is obtained from the inspection device 300 at an operation 1206. The set of inspection data may include at least one image captured of at least a portion of the level indicator using the inspection device 300 as described herein. To obtain the set of inspection data, the operation 1206 may include turning on the LED lighting source 800 to illuminate the section of the level indicator 120 passing through the inspection device 300 and to reduce or eliminate any ambient light which might have entered the interior space of the housing 310 of the inspection device 300. The imaging section 620 may then be activated, for example by powering a camera module thereof. The imaging section 620 may then be initialized, for example by initializing a camera module during a start-up routine. A set of inspection data may then be obtained, for example in the form of image, video, and/or audio data obtained by the imaging section 620 of the inspection device 300. The lighting element 500 may then be powered off and the imaging section 620 or at least one component thereof may then be powered down. Either before, during, or after powering down, a representation of the set of inspection data may be stored at the inspection device 300 (for example at the storage 1010 and/or memory section 1000). Additionally or alternatively, at least a portion of the set of inspection data or representation thereof may be transmitted to a remote computing element external to the inspection device 300 using the communication section 1020.

A set of inspection data may be processed at an operation 1208. An original representation of the set of inspection data may be stored prior to processing, for example at at least one of the storage 1010 and/or memory section 1000 and/or physically remote from the inspection device 300 using the communication section 1030 of the inspection device 300. One or more copies of the set of inspection data may be generated and/or stored at the inspection device 300 or remote thereto. At least one processing operation may be performed on at least one copy o the set of inspection data. For example, in the case of an imaging section including a camera module, the operation 1208 may include performing at least one of three image processing operations: (i) a straight line processing operation; (ii) a hue, saturation, value (HSV) image processing operation; and/or (iii) a background shape processing operation.

Straight line image processing may begin by cropping and stretching a copy of the set of inspection data (e.g., an image in this instance). This may be performed by turning the meniscus into a line and ignoring space outside of the level indicator 120 passing through the inspection device 300. The image may then be converted into a greyscale image and a Canny Edge Detection may be performed. A Hough Line Transform operation may then be performed to find the horizontal line. The horizontal lines may then be grouped, and a largest horizontal line may be selected. The horizontal lines may then be averaged to obtain a final line. A height dimension “Y1” may then be determined.

HSV image processing may begin by cropping a copy of a set of inspection data (an image in this example) with space outside a liquid in the level indicator 120 passing through the inspection device 300 being ignored. The process may focus on a designated HSV value of the background of the level indicator 120 when liquid is not visible within the section of the level indicator 120 passing through the inspection device 300. HSV values may then be masked to as only to show the background. A Rectangle of the masked background may then be found. A lowest liquid height (“Y2”) coordinate of the masked rectangle may then be found. Pixel values 0.5″ below the Y2 value may then be inspected and an average of +/10 pixels in X and Y directions may be obtained. A value of HSV(N) may then be stored, where N=0 (original), 1, 2, 3, . . ., ∞.

Background Shape image processing may begin by cropping a copy of a set of inspection data (an image in this example) with space outside a liquid in the level indicator 120 passing through the inspection device 300 being ignored. Image recognition is then performed relative to a shape (e.g., a circle). The shape in the liquid within the level indicator 120 will either not be seen or will be distorted to a different size than the shape through the level indicator 120 and air. A lowest shape that meets criteria of the shape in air. A value of “Y3” corresponding to a lowest recognized shape may then be calculated.

The process then continues to an operation 1210 where result validation of the set of inspection data is performed and optionally compared to at least one previous result. The process may include comparing the values of Y1, Y2, and Y3 to ensure that the values are equal plus or minus a tolerance amount. The tolerance amount may be a predetermined value based at least in part upon a characteristic of at least one of the inspection device 300 and/or level indicator 120. Additionally or alternatively, the tolerance amount or modification thereof may be provided by a user, such as a customer. If it is determined that the values of Y1, Y2, and Y3 are not equal accounting for the tolerance, the customer may be notified of the issue, for example via the end device 1110. However, if it is determined that the values of Y1, Y2, and Y3 are equal to one another accounting for the tolerance, the value of Y1 may be used as the output height for the liquid level of the level indicator 120 (and thus liquid reservoir 110). The value of Y1 may be stored as a Y value, for example in the format of Y(0) being an original value through Y(N). 100671 The results of height image processing, inspection data may be obtained based at least in part upon an input frequency. Image comparison software may be used or the steps to determine the value of Y1 described above may be used. It is then determined whether there is a difference in the determined Y1 value and a previous Y1 value. If there is no difference, the value of Y(0) is saved as the new Y(N) value, where N is 2 to ∞. However, if it is determined that differences exist, the steps to determine the value of Y1 described above are performed again and the new Y1 value is saved as the new Y(N) value, where N is 2 to ∞. The image may then be stored in a format of Image(N).

The results of HSV processing may be compared to at least one previous result. Image comparison software may be used or the HSV processing steps above may be used. It is determined whether the value of HSV(N) is different from that of HSV(0) If it is determined that no difference exists, no new image is saved. If, however, a difference is detected, the HSV image processing steps above are repeated and a new HSV(N) value and a new Image(N) are stored.

The operation continues to an operation 1212 where inspection data is conveyed and/or result information is provided to an end device 1110. In an exemplary embodiment, high and low inputs are compared to Y(N). If the high and low inputs are within an acceptable range no new image is sent to the end device 1110 for output to the customer. If, however, one or more of the values is outside an acceptable range, an alarm is sent to the customer to indicate the unacceptable level result. Two images, Image(N) and Image(0) may be presented to the customer via at least one end device 1110. A reference scale and high/low lines may be superimposed on one or more images displayed to the customer for ease of understanding the viewed levels.

A history of the liquid height in the level indicator 120 may be stored and/or graphed. For example, a history of the values of Y(0) through Y(N) may be graphed and presented to the customer via at least one end device 1110. The historical data may be used to determine a historical leak rate. The historical leak rate may be used to determine a cost of the leak using a price per volume value provided to the system.

An obtained HSV(N) value may be compared to the HSV(0) value to determine whether an acceptable or unacceptable color change has occurred. For example, the comparison may be used to determine whether the difference is greater than a threshold percentage difference. The threshold percentage difference may be specified by the customer in one exemplary embodiment, although it should be appreciated that a default, a suggested, or an ideal delta threshold delta value may be predetermined or selectable based at least in part upon one or more specific parameters of a liquid used, an inspection device 300 in use, or other criteria. If the difference is less than the threshold percentage difference, the new image is not sent, and the Image(0) image is maintained for reference. However, if the difference is greater than the threshold percentage difference, an alarm may be sent to the customer via at least one end device 1110 that the color value has changed and that the liquid in the liquid reservoir 110 might be contaminated. The customer may be presented with the Image(N) and Image(0) images to compare. A reference scale and high/low lines may be superimposed on one or more images displayed to the customer for ease of understanding the viewed levels. Additionally or alternatively, a color reference guide may be visually presented to the customer. A history of the HSV(N) value may be stored and optionally visually presentable to a customer via graph. The graph may include all or a subset of HSV values, HSV(0) through HSV(N).

As previously noted herein, one or more operations illustrated by or in conjunction with the above description relative to the process of FIG. 12 may be performed, either in whole or in part, at the inspection device 300 (e.g., by processing section 700), at a customer electronic device operating as an end device 1110, at a server functioning as an end device 1110, or at any combination thereof. Furthermore, one or more sets of inspection data, image data, or any data or metadata associated therewith may be stored or processed at the inspection device 300, at a customer electronic device operating as an end device 1110, at a server functioning as an end device 1110, or at any combination thereof.

As is common in many industries, a single customer may have a plurality of liquid reservoirs which they would desire to monitor using apparatuses, systems, and methods consistent with the present disclosure. Such multi-reservoir systems are fully consistent with the present disclosure. For example, a combined interface may permit a user to select one or more of a plurality of liquid reservoirs having an inspection device coupled thereto to remotely monitor any one or more of the liquid reservoirs. Additionally or alternatively, the system may operate in a manner whereby a customer is provided minimal communications by limiting customer interaction to alarm instances to avoid an overflow of information.

Aspects of the present disclosure may be used to improve additional fields, such as in the field of constant oil level indicators, which use a backup reservoir of oil that drops into the system as needed to maintain a proper oil level in the system. For example, an inspection device 300 may be used to visually inspect a level of oil in the backup oil reservoir in this scenario. Still further advantages may be found in scenarios using an oil sight glass (OSG) also referred to as a bottom sediment and water bowl. These devices may be attached to the bottom of an oil reservoir and heavy particles and fluid such as free water migrate down into the bottom of the system which may then be viewable via a translucent section of the OSG. Consistent with the present disclosure, an inspection device 300 may be used to obtain HSV values, a particular contamination status, a water detection status where the OSG includes a level, automated free water drain status based on level, and other inspection data using a camera module of the inspection device 300.

Apparatuses, systems, and methods consistent with the present disclosure may use a stretched and cropped image of the level indicator. An image may be taken by the camera module in real time. The inspection device 300 may then use a cv2.HoughLinesP operation to draw a straight line over the elliptical meniscus at the liquid level in the image. A predetermined, set reference line may be drawn on the same image. This second line may serve as a reference point to provide an accurate fluid level when compared to the first liquid level line. A maximum and minimum fluid level point can also be placed on the image using the same method. A user alert may be created when the fluid level line approaches or surpasses either the maximum or minimum lines. These set points or lines can be added to an image and customized or modified remotely to fit operating conditions or user preferences. In various embodiments, there are no real or physical lines added to the level indicator.

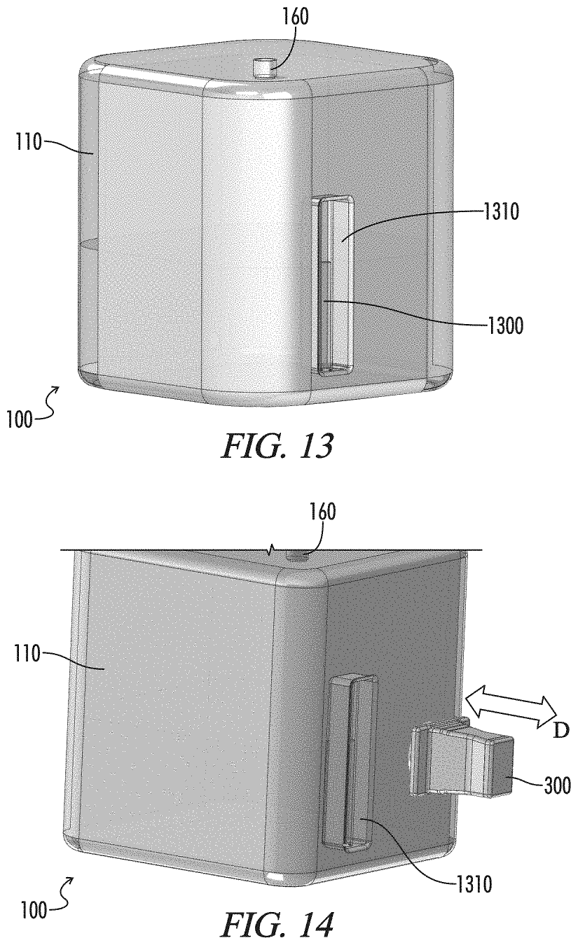

FIG. 13 illustrates a partial side perspective view of an exemplary embodiment of a liquid reservoir system according to aspects of the present disclosure. The liquid reservoir system 100 includes a liquid reservoir 110 having a level indicator 1300 and a location 160. The level indicator 1300 may include at least one component of the level indicator 120 previously described herein. The level indicator 1300 may include a transparent portion configured to permit a visible indicia of liquid level within the liquid reservoir 110. The level indicator 1300 may be recessed within at least a portion of the liquid reservoir 110. One or more sides 1310 may extend outwardly from an outer surface of the liquid reservoir 110 and may be used, at least in part, to couple with an inspection device 300.

FIG. 14 illustrates a partial side perspective view an exemplary embodiment of the liquid reservoir system of FIG. 13 according to aspects of the present disclosure. The inspection device 300 may be configured to couple to the liquid reservoir 110, for example by coupling to a site of the level indicator 1300 via at least one side 1310 of the liquid reservoir 110. The inspection device 300 may couple to the liquid reservoir 110 in a direction D. One or more side 1310 may recess into at least a portion of the liquid reservoir 110 to form a cavity surrounding the level indicator 1300. Additionally or alternatively, at least one side 1310 or portion thereof may extend outwardly from a surface of the liquid reservoir 110.

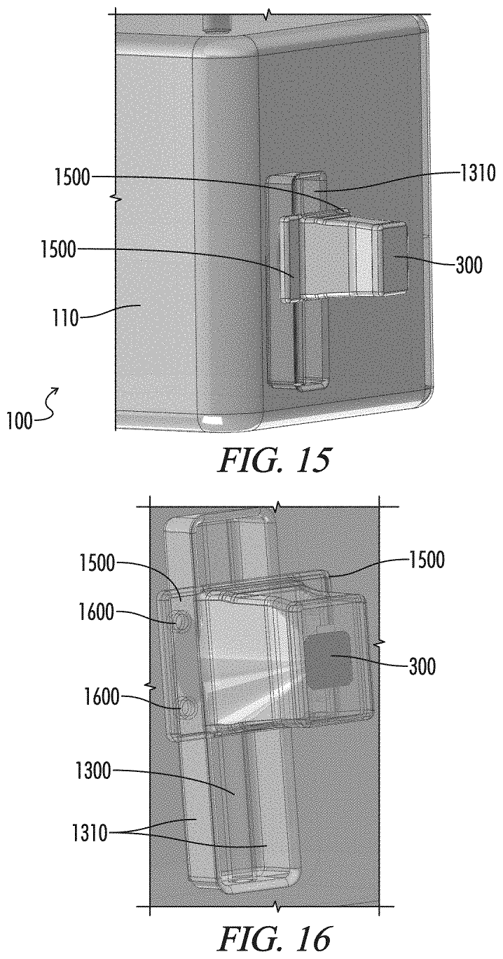

FIG. 15 illustrates a partial side perspective view of the liquid reservoir system of FIG. 13 according to aspects of the present disclosure. The inspection device 300 may include at least one coupling section 1500 configured to permit the inspection device 300 to couple to the liquid reservoir 110, for example at or across one or more sides 1310 thereof. Although illustrated as having two coupling sections 1500 at opposing sides of the inspection device 300 it should be appreciated that any number of coupling sections 1500 may be used, which may be placed at opposing sides of the inspection device or in various embodiments may be part of the liquid reservoir, for example as a quick connect option for the inspection device 300. Additionally or alternatively, at least one coupling section 1500 may be coupleable to at least one of the inspection device 300 and/or liquid reservoir 110 (e.g., as an aftermarket or retrofit element, or otherwise as a modification to the inspection device 300 and/or liquid reservoir 110). At least one coupling section 1500 may be a flange formed as part of the inspection device 300, for example extending outwardly from a surface of the inspection device 300.

FIG. 16 illustrates a partial side perspective view of an exemplary embodiment of an inspection device coupled to a liquid reservoir of FIG. 13 according to aspects of the present disclosure. The inspection device 300 of FIG. 16 includes a plurality of couplers 1600 formed or coupleable to one or more coupling sections 1500. Although illustrated as including a plurality of couplers 1600 it should be appreciated that any number of couplers 1600 may be used, including a single coupler 1600. The coupler 1600 may be any fastening or coupling element configured to place and/or hold the inspection device 300 in contact with the liquid reservoir. In various embodiments, the coupler 1600 may be a magnet, a suction cup, a through hole, or any other fastening or coupling element. At least one coupler 1600 may be configured to configured to couple to an outer surface of the liquid reservoir 110 across the sides 1310 of the cavity housing the level indicator 1300.

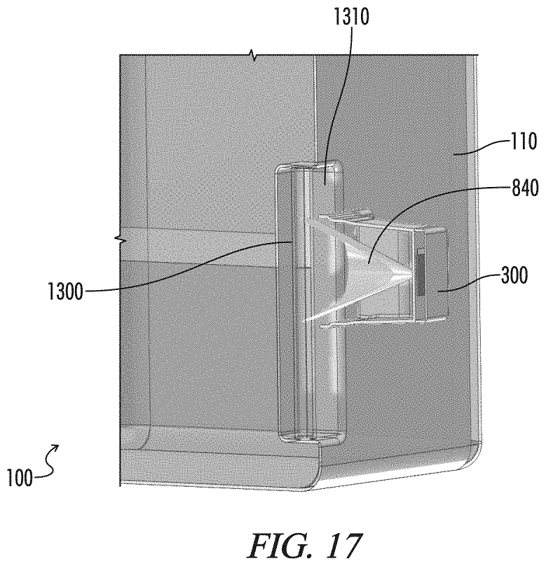

FIG. 17 illustrates a partial cross section view of a liquid reservoir of FIG. 13 according to aspects of the present disclosure. As illustrated by FIG. 17, the inspection device 300 is capable of visually inspecting at least a portion of the level indicator 1300 when coupled to the liquid reservoir 110 according to a field of view 840 of the inspection device 300.

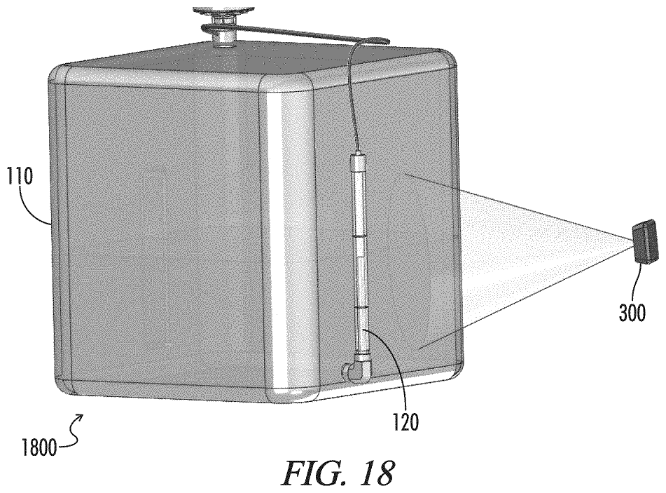

FIG. 18 illustrates a partial side perspective view of an exemplary embodiment of a remote viewing liquid reservoir system according to aspects of the present disclosure. The remote viewing liquid reservoir system 1800 includes a liquid reservoir 100 having a level indicator 120 or 1300 of the types previously described herein, along with an inspection device 300 which is not coupled or mounted to the liquid reservoir 110 but is physically spaced therefrom. The inspection device 300 may be remotely mounted from the liquid reservoir 110 and may be able to inspect a liquid of the liquid reservoir 110 via the level indicator 120 (for example to determine a liquid level, a liquid contamination level, etc.). Although not illustrated in FIG. 18, the inspection device 300 may be coupleable to a mounting location of an element other than the oil reservoir 110. A plurality of inspection devices 300 may optionally be configured to operate independently and/or in a coordinated manner to provide visual inspection capability for one or more liquid reservoirs 100.

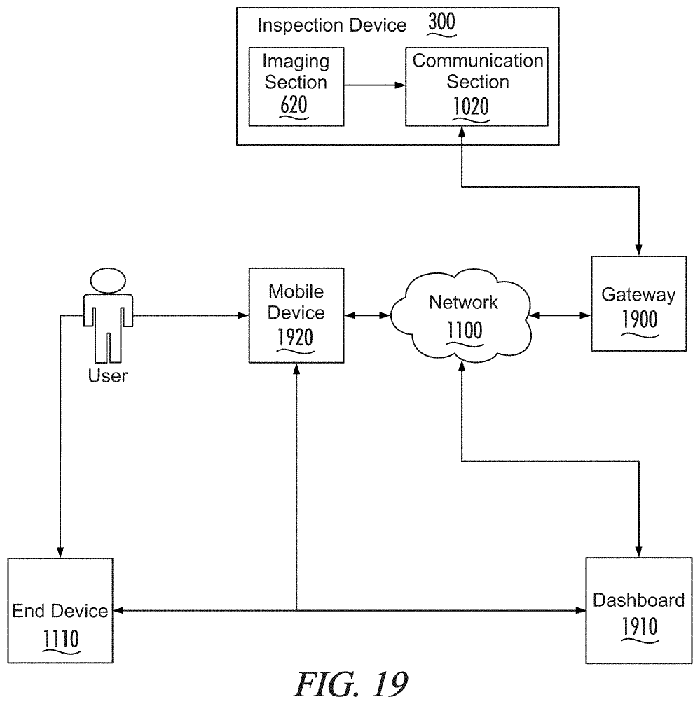

FIG. 19 illustrates a partial network diagram of an exemplary embodiment of a system according to aspects of the present disclosure. A camera of the imaging section 620 of the inspection device 300 may be configured to communicate image data to the communication section 1020 of the inspection device 300, for example via wired configuration such as a ribbon cable, or by any other wired or wireless communication medium. In an exemplary embodiment, the inspection device 300 includes at least one Raspberry Pi hardware element. The communication section 1020 is configured to communicate at least image information with a gateway 1900 via one or more wired and/or wireless communication devices or mediums. In one exemplary embodiment, the communication section 1020 is configured to communicate with the gateway 1900 via one of Bluetooth or other wireless communication (such as Bluetooth Low Energy (BLE)) or a wired connection such as ethernet. One or more file transfer protocols, such as the file transfer protocol (FTP), the secure file transfer protocol (SFTP), the file transfer protocol secure(FTPS), or the like may be used to transmit image data from the communication section 1020 to the gateway 1900.

The gateway 1900 is configured to communicate image data from the inspection device 300 to the dashboard 1910, for example using one or more application programming interface (API) calls from the dashboard (for example, using one or more HTTPS API calls using the SSH file transfer protocol or other file transfer protocol). The dashboard 1910 may be an end device 1110 configured to perform at least one operation, and may optionally be at least a portion of a cloud-based network. For image data transfers where Bluetooth communications are used between a mobile device 1920 associated with a user and the gateway 1900, an Obexftp tool may be used for the communication client and an Obexpush client may be used for the server in various Linux-based embodiments. If the mobile device 1920 communicates via the Bluetooth wireless protocol one or more operations may be performed using a java and/or objective C library that supports one or more mobile device Bluetooth libraries.

The gateway 1900 may be configured to transmit at least one portion of image data or metadata associated with at least a portion of image data to a distributed storage, such as a cloud-based storage network. The user may access image data or metadata associated with image data on either a web portal via at least one of the mobile device 1920 and/or the end device 1110 or a mobile device app executable by the mobile device 1920. At least one set of image data or metadata associated with image data may be stored in the cloud server for easy access. One or more image processing operations may take place at the inspection device 300 (and/or may be optionally performed at the gateway 1900 and/or server, or combination thereof), one or more visual graphs may be processed at the server. The user may be provided with an option to view image data from one or more of the web portal and/or app.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although embodiments of the present invention have been described in detail, it will be understood by those skilled in the art that various modifications can be made therein without departing from the spirit and scope of the invention as set forth in the appended claims.

Each computing device described herein may include at least one or more processors or processing units and a system memory. A processor or controller or processing or control element may also include at least some form of computer readable media. By way of example and not limitation, computer readable media may include computer storage media and communication media. Computer readable storage media may include volatile and nonvolatile, removable and non-removable media implemented in any method or technology that enables storage of information, such as computer readable instructions, data structures, program modules, or other data. Communication media may embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media. As used herein, server is not intended to refer to a single computer or computing device. In implementation, a server will generally include an edge server, a plurality of data servers, a storage database (e.g., a large-scale RAID array), and various networking components. It is contemplated that these devices or functions may also be implemented in virtual machines and spread across multiple physical computing devices.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. An inspection device for inspecting a liquid in a level indicator of a liquid reservoir, comprising:
a housing having an interior space;
a coupler configured to couple the housing to the level indicator of the liquid reservoir, wherein at least a portion of the level indicator is received within the interior space of the housing when the housing is coupled to the level indicator;
a component section including an imaging section configured to obtain at least one set of inspection data relating to the at least a portion of the level indicator; and
a communication section configured to transmit a representation of the at least one set of inspection data from the inspection device.

2. The inspection device of claim 1, further comprising a processing section having a storage, the processing section configured to perform at least one operation on a representation of the at least one set of inspection data and to store a post-processing representation of the at least one set of inspection data at the storage.

3. The inspection device of claim 1, wherein the imaging section comprises a camera module, wherein the at least one set of inspection data is an image of the at least a portion of the level indicator obtained by the camera module.

4. The inspection device of claim 3, further comprising a lighting element within the housing, the lighting element having at least one illumination device configured to illuminate the interior space of the housing while the camera module is operable.

5. The inspection device of claim 4, further comprising a processing section having a storage, the processing section configured to store a plurality of images of the at least a portion of the level indicator obtained by the camera module and to selectively perform at least one operation upon at least one of the plurality of images.

6. The inspection device of claim 3, wherein the housing includes an aperture, and wherein the camera module is configured to provide an image of the interior space of the housing through the aperture, the camera module being configured at a constant distance from the at least a portion of the level indicator.

7. The inspection device of claim 1, wherein the coupler is configured to couple to at least one O-ring at an outer surface of the level indicator.

8. The inspection device of claim 1, wherein the inspection device is configured to receive at least one input parameter via the communication section, the at least one parameter relating to an operating parameter of the inspection device.

9. A system for providing a smart liquid information indicator, comprising:
a liquid reservoir;
a level indicator extending outwardly from the liquid reservoir and configured such that a liquid level in the level indicator matches a liquid level in the liquid reservoir; and
an inspection device for inspecting a liquid in a level indicator of a liquid reservoir, comprising:
a housing having an interior space;
a coupler configured to couple the housing to the level indicator of the liquid reservoir, wherein at least a portion of the level indicator is received within the interior space of the housing when the housing is coupled to the level indicator;
a component section including an imaging section configured to obtain at least one set of inspection data relating to the at least a portion of the level indicator; and
a communication section configured to transmit a representation of the at least one set of inspection data from the inspection device.

10. The system of claim 9, wherein the liquid reservoir includes a headspace, and wherein the system includes a breather device coupled to the headspace of the liquid reservoir at a location thereof.

11. The system of claim 10, further comprising a vent tube coupleable between the level indicator and the breather device at the headspace of the liquid reservoir, the vent tube configured to ensure equal pressurization at the level indicator as at the headsp ace of the liquid reservoir.

12. The system of claim 9, wherein the level indicator includes a breather device.

13. The system of claim 9, wherein the imaging section comprises a camera module, wherein the at least one set of inspection data is an image of the at least a portion of the level indicator obtained by the camera module.

14. The system of claim 13, wherein the inspection device further includes a processing section having a storage, the processing section, the processing section configured to store a plurality of images of the at least a portion of the level indicator obtained by the camera module and to selectively perform at least one operation upon at least one of the plurality of images.

15. The system of claim 14, further comprising:
a network coupleable to the communication section of the inspection device; and
an end device coupleable to the network, the end device including a display unit, the end device configured to receive at least one of the plurality of images from the inspection device and to display the at least one of the plurality of images or a representation thereof via the display unit.

16. The system of claim 15, wherein the end device is configured to receive a plurality of inspection data from the inspection device and display at least a portion of the plurality of inspection data via the display unit as a graph of the at least a portion of the plurality of inspection data over time.

17. A method for providing information relating to a liquid reservoir, the method comprising:
coupling an inspection device to a level indicator of the liquid reservoir;
obtaining at least one inspection device parameter;
obtaining a set of inspection data from the inspection device, the set of inspection data relating to a liquid in a level indicator of the liquid reservoir;
processing the set of inspection data to perform at least one operation on a representation of the set of inspection data; and
selectively conveying information relating to the processed set of inspection data.

18. The method of claim 17, wherein the obtaining the at least one inspection device parameter comprises obtaining the at least one inspection device parameter from an end device external to the inspection device.

19. The method of claim 17, wherein the performing at least one operation on the representation of the set of inspection data comprises performing at least one image processing operation and storing a representation of the processed representation of the set of inspection data.

20. The method of claim 19, wherein the selectively conveying information relating to the processed set of inspection data comprises transmitting the processed representation of the set of inspection data to an end device external to the inspection device via a network, and wherein the method further comprises displaying at least a portion of the processed representation of the set of inspection data at the end device.

21. The method of claim 17, further comprising receiving a plurality of inspection data from the inspection device at an end device external to the inspection device via a network and displaying at least a portion of the plurality of inspection data at the end device as a graph of the at least a portion of the plurality of inspection data over time.
